(19) United States
(12) Patent Application Publication
(10) Pub. No.: US 2021/0170321 A1
(43) Pub. Date: Jun. 10, 2021

(54) CATALYST-FREE AND ACTIVATION-FREE ULTRA-MICROPOROUS CARBON NANOSPHERES FOR LOW PRESSURE CO2 CAPTURE AND A GREEN METHOD OF MAKING SAME

(71) Applicant: Swansea University, Swansea (GB)

(72) Inventors: Saeid Khodabakhshi, Swansea (GB); Enrico Andreoli, Swansea (GB); Sajad Kiani, Swansea (GB); Andrew Ross Barron, Swansea (GB)

(73) Assignee: Swansea University, Swansea (GB)

(21) Appl. No.: 16/936,603

(22) Filed: Jul. 23, 2020

Related U.S. Application Data
(60) Provisional application No. 62/945,910, filed on Dec. 10, 2019.

(51) Int. Cl. B01D 53/02; C01B 32/15; B01J 20/28; B01J 20/20

(52) U.S. Cl. CPC B01D 53/02; C01B 32/15; B01J 20/28019; B82Y 30/00; B01J 20/28071; B01J 20/205; B01J 20/28064

(57) ABSTRACT

The present invention relates to porous carbon spheres via one-step non-catalytic and activation-free chemical vapor deposition method possessing a large volume of ultra-micropores. The ultra-micropore structure allows for with good cyclic stability, easy regeneration, favorable selectivity, and rapid sorption kinetics resulting in high capacity of CO₂ capture at atmospheric and low pressures.

### CROSS-REFERENCE TO RELATED APPLICATIONS

This application claims benefit of U.S. provisional patent application Ser. No. 62/945,910, filed Dec. 10, 2019, which is herein incorporated by reference in its entirety.

### BACKGROUND

### Field

Embodiments of the present disclosure generally relate to a process for the formation of porous carbon spheres via one-step non-catalytic and activation-free chemical vapor deposition method possessing a large volume of ultra-micropores.

### Description of the Related Art

Public concern about global warming as a function of climate change, which is mainly because of man-made greenhouse gas emissions, has been ever increasing. Among greenhouse gases, CO₂ has a huge contribution in the current global climate change because of burning fossil fuels in order to fulfill world energy demands. The need for fossil fuels will continue until they can be entirely replaced with clean and renewable sources of energy. Therefore, one of the most effective measures is the use of the low-cost and practical technologies to capture and sequester CO₂ emissions from source points. Amongst the established method for post-combustion CO₂ capture, aqueous amine solutions are the most feasible and cheapest, but this process suffers from being energy-intensive and corrosive. Besides, the issue of the reaction of amines with acidic components within the combustion gas, amine oxidative degradation can be added to environmental concerns. As a result, porous materials such as activated carbon, zeolites, supported amines, metal oxides, and metal-organic frameworks have been increasingly becoming popular and are being rapidly developed as suitable alternative for the CO₂ capture and storage. However, each type of materials has drawbacks. For example, most MOFs or zeolites despite having high CO₂ uptake show performance decay under humid flue gases. Among all the promising capture materials, porous carbons have received significant attention as a result of their cheapness and availability, hydrophobicity, high stability and surface area, easy preparation, good recyclability, and moderate heat of adsorption.

Carbon spheres ranging in size from nanometres to micrometres have a role in a range of applications such as energy storage and conversion, catalysis, gas adsorption and storage, drug and enzyme delivery, and water treatment. So far, several pathways have been developed for the synthesis of carbon spheres, including nanocasting with silica spheres as hard templates, hydrothermal carbonization of carbohydrates, chemical vapor deposition (CVD), modified Stober synthesis, soft-templating methods, plasma, Friedel-Craft reaction-induced polyaromatic precursors, and spray pyrolysis. These reports present expensive and impractical methods involving a multi-step process and hard work-up such as template removal. Furthermore, these methods generally lead to non-porous spheres with a low surface area or nonuniformly shaped particles limiting their functions in the specific applications. Over the past decade, CVD strategies have been increasingly employed for the preparation of CNTs, graphene, and carbon spheres. However, CVD methods rely on the use of costly or corrosive catalysts and consequently, the catalyst removal still remains a challenge.

One approach for the synthesis of porous carbon is through activation of a carbon precursor by treatment with a base, such as potassium hydroxide (KOH), sodium hydroxide (NaOH) or lithium hydroxide (LiOH) (Tour et al., US Application 2015/0024931; Tour et al., US Application 2015/0056116; Tour et al., US Application 2015/0111018; Tour et al., US Application 2015/0111024; Tour et al., US Application 2016/0001260; Tour et al., US Application 2016/0136613; Ghosh, et al., U.S. Pat. No. 10,232,342). Unfortunately, these hydroxides and their solutions are severe irritants to skin and other tissue. Furthermore, the vapor formed during activation is corrosive and etch typical reaction chambers such as glass. This makes scale-up problematical and impractical. Other activation processes involve the use of strong acids.

It is desirable to have a synthesis of highly porous carbon materials that does not require activation with either strong bases or strong acids. The present invention provides the method for reaching this goal.

### SUMMARY

In one embodiment, new porous carbon spheres and a method for their synthesis that does not require activation by hazardous or corrosive chemicals is provided.

In another embodiment, a new route for the synthesis of porous carbon spheres is reported via one-step non-catalytic and activation-free chemical vapor deposition (CVD) method possessing a large volume of ultramicropores is described. The accessible ultramicropores allowed an effective interaction with CO₂ gas molecules resulting in high capacity of CO₂ capture at atmospheric and low pressures for a sustainable environment. The CVD method was conducted at different temperatures ranging from 600-900° C. The preferential temperature is about 800° C. Specific surface area and total pore volume are slightly influenced by synthesis temperature leading to appreciable change in overall capture capacity. At atmospheric pressure, the highest CO₂ adsorption capacities of about 4.0 mmol/g and 2.85 mmol/g at 0° C. and 25° C. were found for the best carbon spheres, respectively. In addition, at low pressure of 0.15 bar, the CO₂ adsorption capacities of 2.0 mmol/g at 0° C. and 1.1 mmol/g at 25° C. were determined for the best carbon spheres. Synthesized carbon spheres also demonstrated a good cyclic stability, easy regeneration, favorable selectivity, and rapid sorption kinetics.

The abovementioned and other purposes of the present invention, characteristics and advantages will be obvious and clear after referring to the detailed description, preferred embodiment and the attached figures.

### BRIEF DESCRIPTION OF THE DRAWINGS

So that the manner in which the above recited features of the present disclosure can be understood in detail, a more particular description of the disclosure, briefly summarized above, may be had reference to embodiments, some of which are illustrated in the appended drawings. It is also noted, however, that the appended drawings illustrate only exemplary embodiments. And are therefore not to be considered limiting in scope, may be admit to other equally effective embodiments.

FIG. 1 illustrates a schematic representation of the precursor determination and temperature optimization map to produce carbon spheres by CVD method. Temperatures are related to Zone 2, where carbon spheres are deposited.

FIG. 2 is the Fourier transfer infrared spectra for precursor, intermediate, and carbon spheres (a) and Raman spectra for carbon spheres prepared at 800° C. at different wavelengths (b).

FIG. 3 is a typical scanning electron microscope image (a), transmission electron microscope image (b), and scanning transmission electron microscope images (c and d) of carbon spheres.

FIG. 4 is a typical scanning transmission electron microscope image and elemental mapping images of carbon spheres prepared at 850° C.

FIG. 5 illustrates (a) X-ray photoelectron spectroscopy (XPS) survey spectrum of carbon spheres prepared at 800° C. showing carbon and oxygen are the only elements detected on the surface of the sample. (b) XPS C1s narrow region spectrum of carbon spheres prepared at 800° C. (c) XPS O1s narrow region spectrum of carbon spheres prepared at 800° C.

FIG. 6 illustrates the pore size distribution calculated by NL-DFT for carbon spheres.

FIG. 7 illustrates the proposed mechanism for the carbon sphere formation from pyromellitic acid by CVD method.

FIG. 8 is the CO₂ uptakes for the synthesized carbon spheres up to 10 bar (a) and up to 1 bar (b) at 25° C. CO₂ and N₂ uptakes at 0° C. to 25° C. and up to 1 bar (c).

FIG. 9 is a recyclability test for CO₂ adsorption at 40° C. for carbon spheres prepared at 800° C.

FIG. 10 shows schematic illustration of the setup used for the measurement of CO₂ capture.

FIG. 11 is the Raman spectra for carbon spheres prepared at 700° C. (a) and carbon spheres prepared at 900° C. (b).

FIG. 12 is a typical scanning electron microscope image of carbon spheres prepared at 700° C.

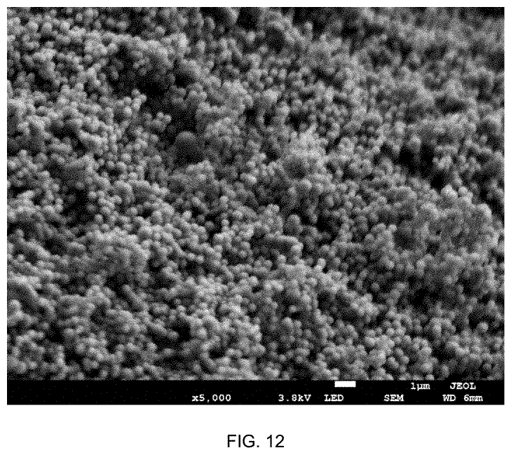

FIG. 13 is a typical scanning electron microscope images of carbon spheres prepared at 900° C.

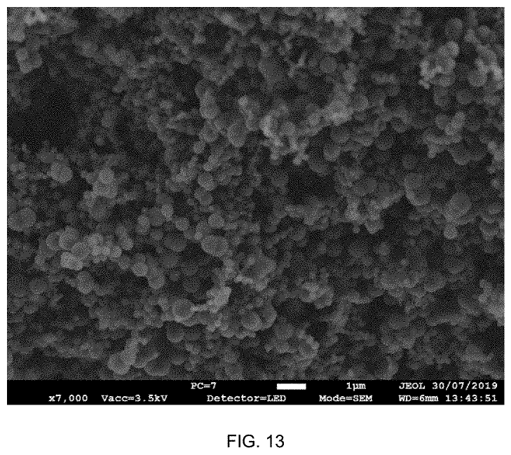

FIG. 14 is the X-ray diffraction patterns for carbon spheres prepared at 800° C.

FIG. 15 is N₂ (a) and CO₂ (b) sorption isotherms at −196.15° C. and 0° C. for synthesized carbon spheres prepared at 700, 800 and 900° C.

FIG. 16 is the thermogravimetric analysis-differential thermal analysis curve of carbon spheres prepared at 800° C.

FIG. 17 is an image of the surface wettability testing of carbon spheres prepared at 800° C. The contact angle was determined as 160° (greater than 90° is hydrophobic).

FIG. 18 is a photographic image of the carbon spheres prepared at 800° C. aggregation on the surface of water as a result of high hydrophobicity.

FIG. 19 is the adsorption kinetics for carbon spheres prepared at 800° C.

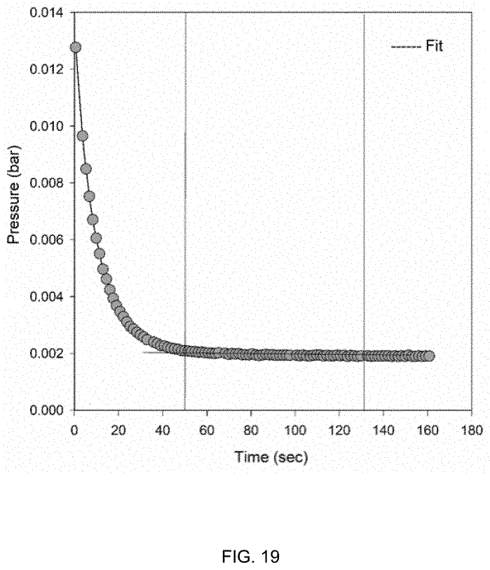

FIG. 20 is a Van′t Hoff plots of isosteric heat of adsorption for carbon spheres prepared at 800° C.

Various components of the same type may be distinguished by following the reference label by a letter that distinguishes among the similar components and/or features.

### DETAILED DESCRIPTION

As a comparison, to show the merits of the present pathway to carbon spheres, Table 1 lists some reported activation methods for the synthesis of porous carbon materials with a comparison between the capacities (mmol/g) of maximum CO₂ uptake on various carbon spheres at 1 bar.

TABLE 1

| Method and type of | Uptake | Uptake | Selectivity | |
|---|---|---|---|---|
| activation | temp. | (mmol/g) | CO₂:N₂ | Reference |
| Pyrolysis HNO₃ | 30° C. | 2.57 | 4.81 | Sun et al. |
| activation | | | | |
| Stöber synthesis | 0° C. | 2.63 | 9.4 | Li et al. |
| Pyrolysis-potassium | 0° C. | 6.6 | — | Ludwinowicz |
| oxalate monohydrate | | | | et al. |
| activation | | | | |
| Condensation reactions | 25° C. | 2.47 | 41 | Mohanty |
| | | | | et al. |
| Stöber synthesis | 23° C. | 4 | — | Marszewska |
| | | | | et al. |
| Pyrolysis- | 25° C. | 3.65 | — | Chen et al. |
| KOH activation | | | | |
| Pyrolysis- | 25° C. | 4.61 | 25 | Ren et al. |
| KOH activation | | | | |
| Pyrolysis- | 25° C. | 4.3 | — | Zhang et al. |
| KOH activation | | | | |
| CVD, activation-free | 25° C. | 2.85 | 30 | Present |
| | | | | invention |
| CVD, activation-free | 0° C. | 4.0 | 23 | Present |
| | | | | invention |

Furthermore Table 2 lists CVD methods for carbon spheres production. As can be seen, the CVD method mainly feeds on hydrocarbon gases and liquids such as acetylene and ethylene and demands a metal or silica-based catalyst, while we used a solid feedstock instead without catalyst. However, both catalyst price or catalyst removal are the main drawbacks of these available approaches. The carbon spheres prepared by our catalyst-free strategy, however, requires a usual pyrolysis temperature to deliver sphere size of approximately 200 nm which is still smaller than those published in previous literature.

TABLE 2

| | | Deposition | | Sphere | |
|---|---|---|---|---|---|
| | | Temperature | | size | |
| Carbon | | (° C.)/time | Porosity | average | |
| feedstock | Catalyst | (min) | type | (nm) | Reference |
| Ethylene | NiFe-LDHs | 900/60 | Non-porous | 740 | Carrasco et al |
| Acetylene | Fe-KIT-6 | 800 | Meso- | 750 | Karthikeyan et al. |
| | | | porous | | |
| Ethylene | Kaolin supported | 750-900 | Not | 400 and | Miao et al. |
| | transition metal | | measured | 2000 | |
| Ethylene | Mesoporous | 800 | Meso- | 260 | Chen et al. |
| | silica template | | porous | | |
| Ethylene | Mesoporous | 800 | Meso- | 400 | Kukułka et al. |
| | silica template | | porous | | |
| Polypropylene | Mesoporous | 900 | Non-porous | 1000 | Tripathi et al. |
| | silica template | | | | |
| Styrene, Toluene, | None | 900-1200 | Non-porous | 300-700 | Jin et al. |
| Benzene, Hexane, | | | | | |
| Cyclohexane | | | | | |
| and Ethene | | | | | |
| Pyromellitic | None | 700-900 | Micro- | 200 | Present |
| acid | | | porous | | invention |

The present invention contemplates new and improved systems and methods that resolve the above-referenced difficulties and others.

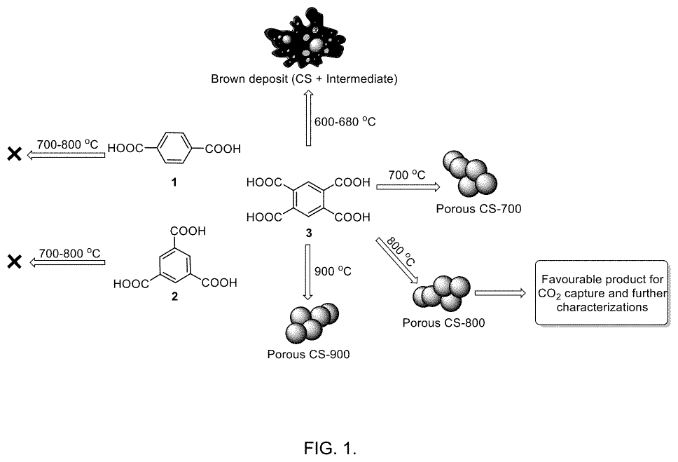

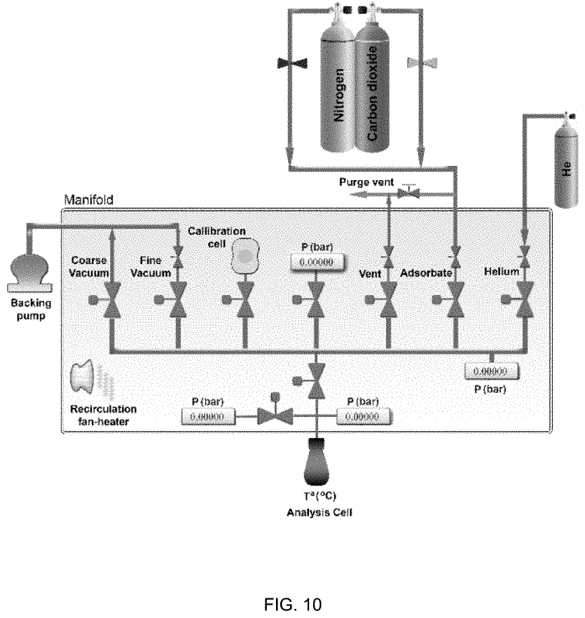

FIG. 1 shows a schematic of the claimed method to produce desired carbon spheres from pyromellitic acid, and the inability to make carbon spheres from terephthalic acid or trimeric acid. In case of terephthalic acid, the precursor is decomposed into highly volatile components and no carbon residue remained in either zone 1 or zone 2 of the CVD tube shown in FIG. 10. In contrast, trimeric acid has a higher boiling point than pyromellitic acid and by raising the temperature of Zone 1 even up to 700° C., no carbon spheres were formed in the CVD chamber and only amorphous carbon residue was observed. It seems that thermal treatment of terephthalic acid leads to structure collapse and generation of unstable or volatile species, which are not able to be recombined. In the contrary, decomposition and recombination of trimeric acid occur in zone 1 which is likely because of the formation of more stable species compared to terephthalic acid. In case of pyromellitic acid, the condensation of pyromellitic dianhydride was observed at 600° C. with no trace of pyrolyzed compound. However, raising temperature from 600° C. to 680° C. gave impure carbon containing pyromellitic dianhydride. After rigorous screening, the temperature above 700° C. was found to be the condition in which carbon spheres could be purely formed. It is assumed that the formation of pyromellitic dianhydride is a key step prior to decomposition leading the direction towards sphere nuclei formation. However, the carbon sphere product obtained from 800° C. showed better performance for CO₂ capture.

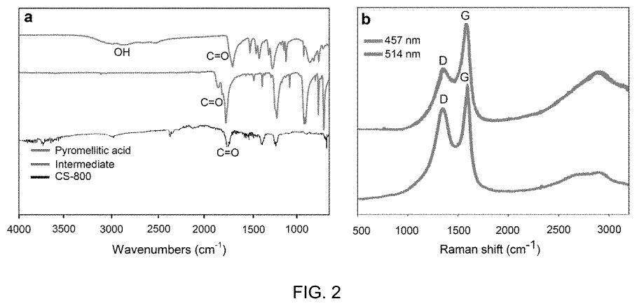

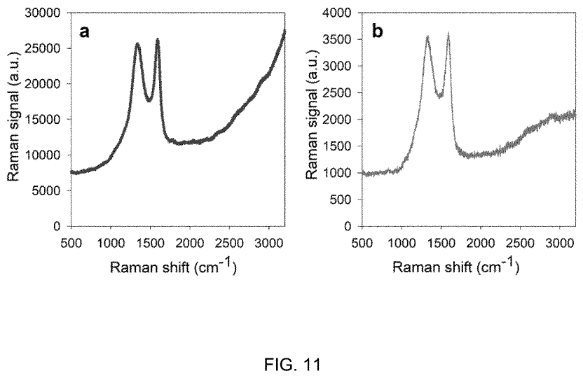

FIG. 2a shows the FT-IR spectra for the pyromellitic acid precursor, the pyromellitic dianhydride intermediate, and final carbon sphere product. The formation of pyromellitic dianhydride during thermal treatment is confirmed by obvious shift in C═O peaks from 1700 cm⁻¹ (carboxylic acid, red line) to 1800 cm⁻¹ (cyclic anhydride, blue line). Also, the disappearance of stretching bonds of OH in intermediate (blue line) is an additional proof for the formation of pyromellitic dianhydride. The spectrum for carbon spheres prepared at 800° C., however, does not present any distinct peak and the straight line confirms the complete formation of pyrolyzed product. FIG. 2b demonstrates the Raman spectra for carbon spheres prepared at 800° C. at two different wavelengths 457 nm and 514 nm), both spectra clearly show peaks arising from sp² and spa carbons at ˜1350 cm⁻¹ and ˜1580 cm⁻¹, respectively. In addition, we note the presence of several peaks in the region of 2500-2800 cm⁻¹ that are indicative of the presence of sp² carbon structures. The Raman spectra suggest both an amorphous nature for the as-synthesized carbon spheres with a covalent random network including both sp³ and sp² hybridization while sp² peak is dominant. Raman spectra for carbon sphere prepared at 700° C. and 900° C. can be also seen in FIG. 11.

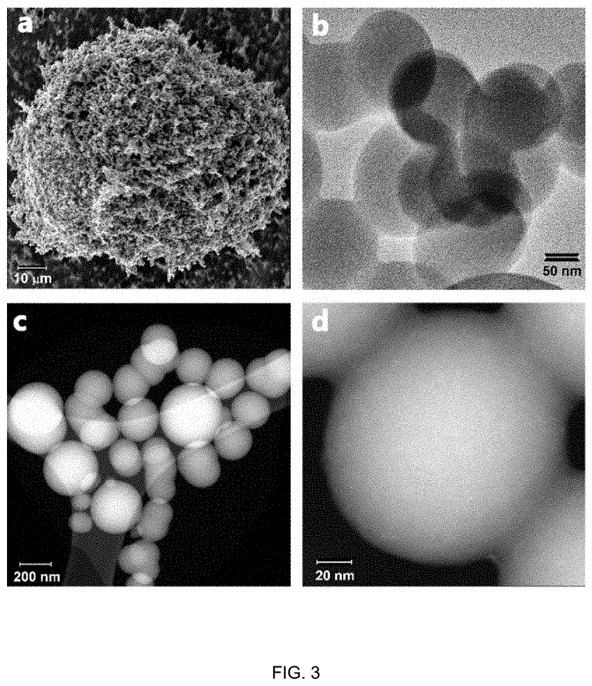

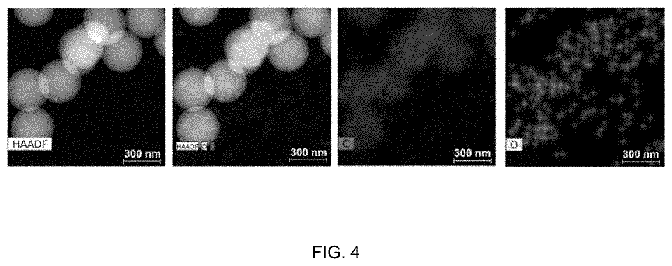

As can be seen from FIG. 3a, the SEM image for carbon sphere prepared at 800° C. shows a large area of aggregated spheres. On further screening by TEM and scanning transmission electron microscopy (STEM) it was revealed that they hold a spherical morphology with the average diameter of 300 nm. The SEM for carbon spheres prepared at 700° C. and 900° C. shown in FIG. 4 also showed similar morphology to carbon sphere prepared at 800° C.

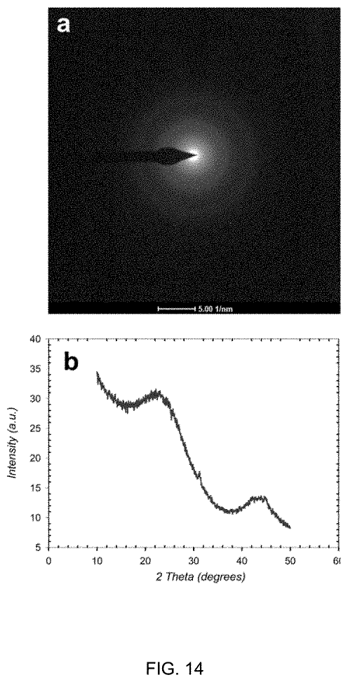

The EDS mapping analysis of the carbon spheres represents a carbon content of 96.35 atomic % and an oxygen content of 3.64%. These results are also close to those recorded by elemental analysis, with a C and O content of 96.43% and 3.57%, respectively. The crystallinity of the carbon spheres prepared at 800° C. was studied by SAED showing no crystalline structure. In addition, the X-ray diffraction spectrum also showed an amorphous nature for the carbon spheres prepared at 800° C. (FIG. 14).

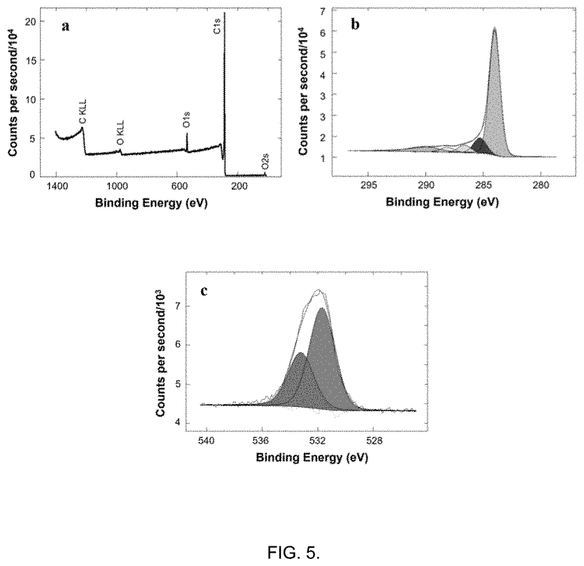

The surface composition of sample carbon spheres prepared at 800° C. was analyzed using XPS (FIG. 5). The survey spectrum confirms the presence of carbon and oxygen only in atomic concentration of 94.7% and 5.3%, respectively. The C 1s narrow region spectrum has been deconvoluted in four peaks. A main contribution to the intensity of the signal is due to sp² carbon at binding energy 284.0 eV, sp3 carbon is found at 285.3 eV instead. There are also peaks related to oxidized carbon, C—O at 286.6 eV, and C═O at 288.1 eV. Graphitic π-π* shake-up satellites where fitted with a broad peak centered at 290.1 eV. These results confirm the presence of partially oxidized aromatic structures on the surface of the sample in line with the results obtained from Raman and elemental analysis. The O1s narrow region spectrum confirms these observations. The oxygen signal was deconvoluted into two peaks, an O═C peak at binding energy 531.7 eV and an O—C peak at 533.2 eV. The corresponding O═C/O—C oxygen atomic ratio is 1.8.

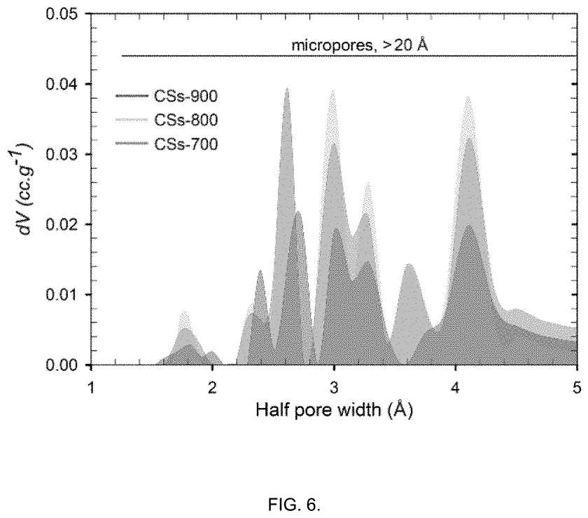

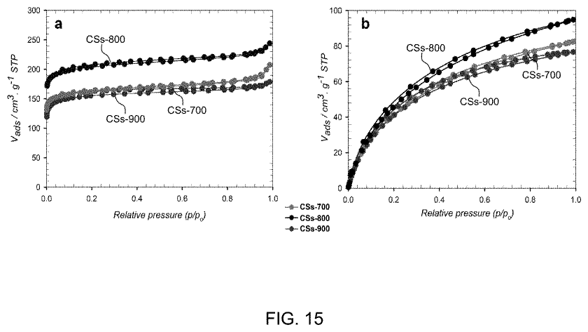

Although the sphere formation from pyromellitic acid is not affected by changing temperature from 700° C. to 900° C., the textural properties can be slightly influenced. To find out the effect of carbonization temperature on the CO₂ capture capacity, N₂ and CO₂ adsorption measurements were performed (FIG. 15) in which surface areas were measured by the BET method using N₂ at 77 K and pore size distribution by density functional theory (DFT) using CO₂ at 273 K. FIG. 6 clearly presents distribution of pores for all as-synthesized carbon spheres in the range below 1 nm confirming the high abundance of narrow micropores which are mainly responsible for CO₂ molecules capture at low pressures.

As can be seen from the Table 3, the pore volume and pore size slightly change as a function of carbonization temperature. Table 3 also lists C, 0, H content of carbon spheres measured by elemental analysis.

TABLE 3

| Synthesis | S_{BET} | Total pore | Atomic content (%) | | |
|---|---|---|---|---|---|
| temperature | (m² · g⁻¹) | volume (cm³ · g⁻¹) | C | H | O |
| 900° C. | 635.3 | 0.156 | 94.80 | 1.94 | 3.26 |
| 800° C. | 804.3 | 0.192 | 92.6 | 1.82 | 5.58 |
| 700° C. | 639.7 | 0.168 | 85.79 | 2.41 | 11.8 |

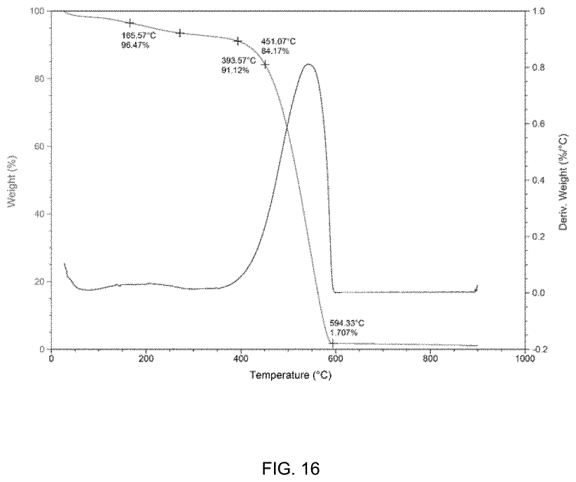

Thermogravimetric analysis (TGA) at the temperature ranging from 23° C. to 900° C. under airflow was used to check the thermal stability of carbon spheres. The TG profile for the synthesized carbon spheres shows a similar oxidation behavior to those previously reported in the literature with a negligible weight loss before 450° C. A slight mass loss during the initial stage can be attributed to the absorbed water and a single step degradation of spheres is obvious between 450-580° C. (FIG. 16).

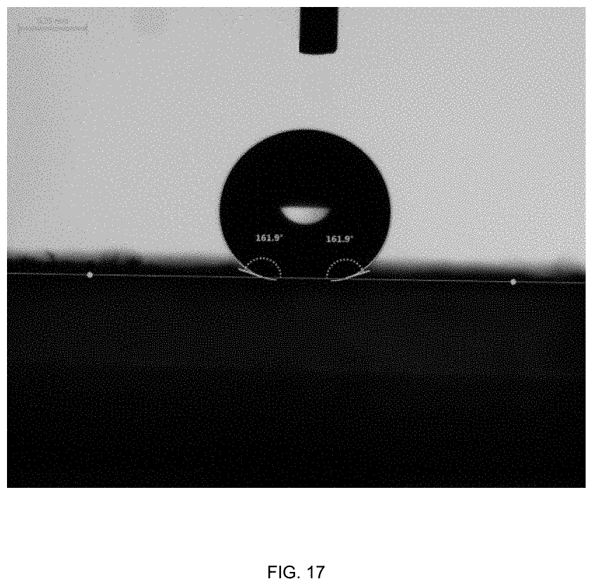

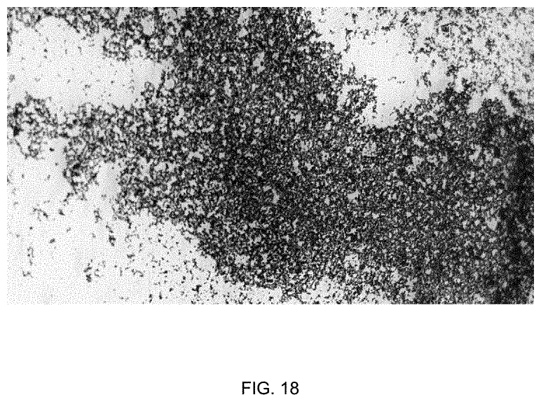

Wettability of the carbon spheres prepared at 800° C. was also evaluated via water contact angles measurement (FIGS. 17 and 18). Interestingly, a large contact angle of 161.5° was determined for carbon spheres prepared at 800° C. showing its superhydrophobic nature. The surface roughness generated by the morphology of spheres can be as a result of strong hydrophobicity. Therefore, high level of hydrophobicity along with the presence of narrow micropores can make the carbon spheres prepared at 800° C. appropriate adsorbent in humid conditions which is discussed later.

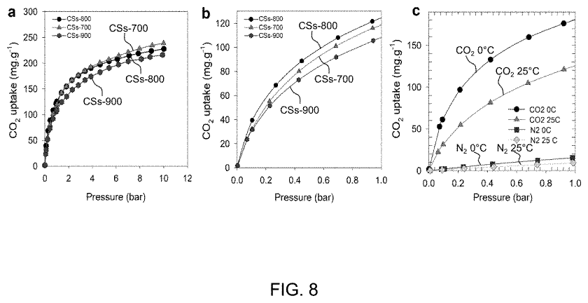

By a volumetric gas adsorption instrument, the performance of the prepared carbon spheres for CO₂ capture was assessed at different pressures ranging from 0.1 to 10 bar while keeping at four constant temperature of 0° C., 25° C., 35° C., and 45° C. As can be seen from FIG. 8, the CO₂ adsorption capacity of as-synthesized carbon spheres prepared at 800° C. was able to maintain a high level of performance regarding to previous reports. However, the CO₂ uptake at all temperature tested and 1 bar revealed the higher performance for carbon spheres prepared at 800° C., over samples prepared at 700° C. and 900° C. Therefore, carbon spheres prepared at 800° C. was chosen as the desirable sample and further characterizations and CO₂ adsorption investigations under flue-gas-like conditions such as a partial pressure of 0.15 bar were performed focusing on this sample. FIG. 8 presents CO₂ capture plots for all three samples, in which carbon spheres prepared at 700° C. shows uptake of 5.4 mmol/g at 10 bar as a high performer. However, carbon spheres prepared at 700° C. can uptake CO₂ at 25° C. and pressure above 6 bar slightly more than carbon spheres prepared at 800° C., while they showed more adsorption capacity at 25° C. and 1 pressure up to 6 bar. Considering the dynamic molecular diameter of CO₂, which is 2.09 Å, it has been proved that pores with diameters lower than 10 Å are suitable for CO₂ adsorption at atmospheric pressure. It can be also concluded that almost entire volume of micropores available in carbon spheres are readily accessible. However, an appreciable plateau in the isotherms at pressure higher than 2 bar implies that the carbon spheres cannot adsorb larger CO₂ amount at higher pressure confirming the lack of mesopores. In fact, the significant role of micropores for CO₂ adsorption at pressure lower than 1 bar has been also well described in the previous literature. FIG. 8b also demonstrates CO₂ uptake for three carbon spheres at 25° C. and pressure up to 1 bar, where carbon spheres prepared at 800° C. is dominant in terms of efficiency with uptake of 1.1 mmol/g (0.15 bar) and 2.85 mmol/g (1 bar). FIG. 8c shows the CO₂ and N₂ uptake at different pressures up to 1 bar and temperatures of 0° C. to 25° C. As can be expected for physisorption, the volume of CO₂ adsorbed on carbon spheres from 0° C. to 25° C. decreases significantly by 45% and 28% and at 0.15 and 1 bar, respectively.

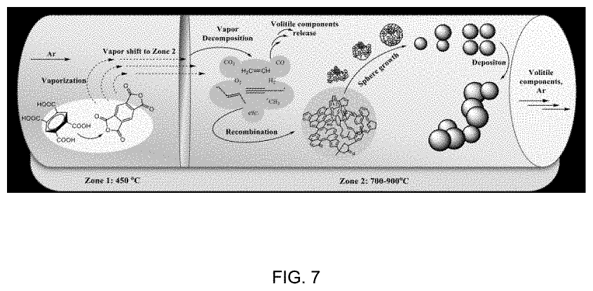

A typical flue gas stream emanated from coal-fired power plants comprises approximately 15% of CO₂ and 75% of N₂; while the rest includes O₂, H₂O, sulfur oxides (SOₓ), and nitrogen oxides (NOₓ). Therefore, a candidate CO₂ capture adsorbent must also exhibit high selectivity for CO₂ over N₂ to ensure the technical feasibility of the presented approach for an adsorption-based CO₂ capture unit which is critical to CCUS economics. FIG. 7 also indicates the selectivity of CO₂ over N₂ at both 0° C. to 25° C. The selectivity values for carbon spheres prepared at 800° C. were determined based on the quantity of CO₂ and N₂ adsorbed at their estimated partial pressures (0.15 and 0.85 bar, respectively) as 23 and 30 at 0° C. to 25° C., respectively.

As a comparison of low-pressure CO₂ adsorption between carbon spheres prepared at 800° C. (2.0 mmol/g at 0° C. and 1.1 mmol/g at 25° C.) are higher than the value reported for holey graphene frameworks (0.91 mmol/g at 0° C. and 0.53 mmol/g at 25° C.), and metal-organic frameworks (0.75 mmol/g at 0° C. and 0.4 mmol/g at 20° C.), KOH activated carbon derived from waste wool (1.3 mmol/g at 0° C. and 0.8 mmol/g at 20° C.). As a comparison, the carbon spheres prepared at 800° C. exhibits a CO₂ uptake of 2.85 mmol/g at 1 bar and 25° C., making it at least as good as the best materials that are prepared with activation by acidic or caustic activators. The adsorption capacity of carbon spheres prepared at 800° C. of the present invention is more than non-KOH activated carbon.

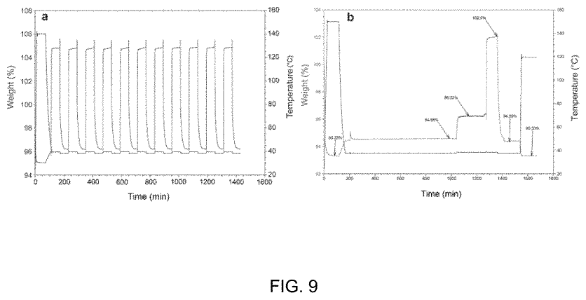

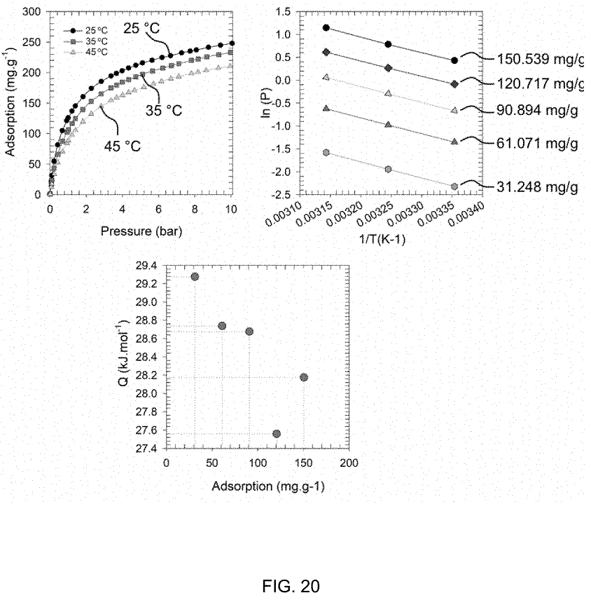

In an adsorption-based capture unit, estimation of isosteric heat of adsorption (Qst) plays also as a key factor through which the local changes in the temperature of both adsorbent inside an adsorption column during the sorption process can be controlled. Overall gas separation yield can be effected as the local adsorption equilibria and kinetics are function of the heat of adsorption. Here, the CO₂ Qst of the carbon spheres of the present invention was calculated by adsorption isotherms measured at 25, 35, and 45° C. and determined as between 27.5-29.5 kJ/mol with the CO₂ amount adsorbed varying from 0.1 to 5.5 mmol/g (FIG. 20). This value, which is in the range of ordinary physisorption (<40 kJ/mol), shows the energy required for regeneration and the interaction strength between CO₂ molecules and carbon spheres of the present invention, which is roughly higher than those previously reported for some porous carbons and spheres providing facile desorption during regeneration. In addition to selectivity and heat of adsorption, more realistic conditions should be considered for practical applications. However, recyclability and stability over multiple runs is also another critical factor. The regenerability of as-synthesized carbon spheres of the present invention was examined by TGA method. FIG. 9 shows 11 cycles of adsorption and desorption with no appreciable changes on the CO₂ uptake (˜1.8 mmol/g) proving the potential applications in practical processes. A complete regeneration was observed at 40° C. after 15 min. Due to lack of functionalities and fast kinetic of sorption in multiple runs, it can be assumed that the isotherms follow a physical sorption mechanism. Considering the nature of physical adsorption, increasing the temperature may reduce the porous carbon capacity for CO₂ capture.

By taking into account that as-synthesized carbon spheres of the present invention benefit from a high level of hydrophobicity, herein, the effect of humidity on the CO₂ uptake performance of carbon spheres prepared at 800° C. was also evaluated through a TGA-CO₂ sorption test under humidified conditions (FIG. 9). The experiment, however, included a series of sorption steps at different temperatures up to 140° C. As can be seen from FIG. 9, in the first step, the carbon spheres prepared at 800° C. as sorbent underwent desorption by dry argon (Ar) at 140° C. Then, the sorbent was exposed to a flow of wet Ar which led to increase in weight of sorbent by almost 2% as a result of partial hydration of carbon spheres prepared at 800° C. surface. In the next step, by exposing the sorbent to wet CO₂, the overall sorption mass of ˜8% was observed. Therefore, 6% difference (8%ₜₒₜₐₗ-2%_{wetAr}=6%) can be associated to adsorbed CO₂ at 40° C. Although the CO₂ uptake of 6% (˜1.3) in humid conditions is lower than that of dry conditions (1.8 mmol/g), sorption kinetics remained fast showing a decent efficiency of carbon spheres prepared at 800° C. After adsorption isotherm reached to the equilibrium, the saturated sorbent was exposed again to dry Ar at 25° C. for desorption. Increasing the temperature during desorption did not show any additional effect and it is obvious that all adsorbates were fully released from the sorbent at ambient temperature with no need to extra heating. As it was expected from high contact angle calculated for carbon spheres prepared at 800° C. and high abundance of ultramicropores (>1 nm), carbon spheres prepared at 800° C. cannot host water molecules to an appreciable extent showing its water resistibility and outstanding advantages over unstable adsorbents in humid conditions such as some reported zeolites and MOFs.

### Examples

STEM and HRTEM images of the spheres were performed using a JEOL 2100F Transmission Electron Microscope. SEM images of the spheres were obtained with JEOL 7800F FEG SEM (JEOL, Akishima, Tokyo, Japan). The Raman data of the prepared spheres were recorded at room temperature on a Renishaw inVia Raman Microscope (Renishaw plc, Miskin, Pontyclun, UK) with excitation wavelength of 457, 514, and 633 nm. The elemental analyzer (Vario EL cubewas, Germany) was used to determine the amount of carbon, hydrogen and oxygen. The samples were characterized by FT-IR model a Thermo Scientific Nicolet iS10 FT-IR Spectrometer. Thermogravimetric analysis (TGA) was carried out on 10-mg samples using a TA Instruments SDT Q600 at a heating rate of 5 C/min from room temperature to 900° C. in air. N₂ adsorption/desorption isotherms were obtained using a Quadrosorb SI (Quantachrome Instruments, Boynton Beach, Fla., USA). Specific surface area was calculated based on the Brunauer-Emmett-Teller (BET) method, and pore size distribution was determined using the density functional theory (DFT) method. XPS was performed using a Kratos Axis Supra (Kratos Analytical, Japan) utilizing a monochromatic Al—K_{α} X-ray source (K_{α}=1486.58 eV), 15 mA emission current, magnetic hybrid lens, and slot aperture. Region scans were performed using a pass energy of 40 eV and step size of 0.1 eV. Peak fitting of the narrow region specra was performed using a Shirley type background, and the synthetic peaks were of a mixed Gaussian-Lorentzian type. Carbon sp² was used for charge reference assumed to have a binding energy of 284 eV. All the adsorbents were degassed at 160° C. under vacuum for 2 h prior to adsorption study. CO₂ adsorption performance of carbon spheres were measured volumetrically in an Isorb apparatus (Germany) at four different temperatures (0, 25, 35 and 45° C.) and pressures from 0.1 to 10 bar. Degasification temperature was internally controlled by covering the cell, containing the sample, with a thermojacket, while the adsorption temperature was adjusted by a jacketed beaker connected to a circulating bath containing water and ethylene glycol. For each experiment, about 200 mg of carbon spheres was used for the adsorption studies. Ultra-pure CO₂ (99.9%) and N₂ (oxygen free) as gas sources were used throughout the experiments. N₂ adsorption experiments at 25° C. and different pressures were also recorded through the same procedure for CO₂. The laboratory-scale set-up employed to conduct CO₂-adsorption experiments is illustrated in FIG. 1. Static contact angle values were measured for solid-liquid interface using DSA25 Expert Drop Shape Analyzer and analyzed using ADVANCE software (KRUSS GmbH) equipped with the automated camera at 25° C. and 35% humidity. The sessile drop method was performed for the purpose of measuring contact angle values according to the Young-Laplace equation, this was completed using a contour-fitting algorithm. Each of the contact angle measurements were reiterated five times to minimize standard errors. It is to be noted that, each of the aged glass surfaces were prepared after dispersing a specific amount of sphere 1 g in 100 mL in isopropanol solution, then sprayed on the surface, and dried in the oven at 115° C. for 12 h. In contact angle measurements, the syringe of a hypodermic needle was filled with 1 mL of deionized water, calibrated, then fitted in the chamber, and loaded gently on the substrate. NOVA 2000e volumetric adsorption analyzer (Quantochrome) was carried out to assess the surface area, pore volume, and pore size distribution using N₂ (−196° C., 99.9% purity) and CO₂ (0° C.). For each adsorption-desorption analysis, the cell was filled with a specific amount of sample, it was then weighted and loaded into the degas port. After this, the heating pockets were attached, and then degassed under a vacuum pump for 8 h at 150° C. Once degassing time was completed, each carbon sphere sample was backfilled with helium to avoid the sample being dosed with CO₂ before analysis. It is noted that, carbon-based materials are mostly non-microporous and highly sensitive. The specific surface area (SBET) measurement was taken from N₂ adsorption and analyzed using the Brunauer-Emmett-Teller (BET) model within relative pressure (p/p₀) of 0.05-0.20. Incremental pore size distribution and pore volume were taken from CO₂ measurements and calculated using the DFT method.

Example 1. Pyromellitic acid (96%) was purchased from Sigma-Aldrich and used without further purification. In a typical procedure, 1 g of pyromellitic acid were placed in a ceramic boat and inserted into the zone 1 of a tubular furnace under argon (200 mL/min) and at atmospheric pressure. The temperature of zone 2 was raised to 700° C. with a heating rate of 1° C./s. When the desired temperature was reached, the temperature of zone 1 was also increased to 450° C. and left for 30 min. Then, the furnace was cooled down to room temperature under argon, and the pure carbon spheres were collected from the quartz tube and used without any further process.

Example 2. Pyromellitic acid (96%) was purchased from Sigma-Aldrich and used without further purification. In a typical procedure, 1 g of pyromellitic acid were placed in a ceramic boat and inserted into the zone 1 of a tubular furnace under argon (200 mL/min) and at atmospheric pressure. The temperature of zone 2 was raised to 800° C. with a heating rate of 1° C./s. When the desired temperature was reached, the temperature of zone 1 was also increased to 450° C. and left for 30 min. Then, the furnace was cooled down to room temperature under argon, and the pure carbon spheres were collected from the quartz tube and used without any further process.

Example 3. Pyromellitic acid (96%) was purchased from Sigma-Aldrich and used without further purification. In a typical procedure, 1 g of pyromellitic acid were placed in a ceramic boat and inserted into the zone 1 of a tubular furnace under argon (200 mL/min) and at atmospheric pressure. The temperature of zone 2 was raised to 900° C. with a heating rate of 1° C./s. When the desired temperature was reached, the temperature of zone 1 was also increased to 450° C. and left for 30 min. Then, the furnace was cooled down to room temperature under argon, and the pure carbon spheres were collected from the quartz tube and used without any further process.

Example 4. Pyromellitic acid (96%) was purchased from Sigma-Aldrich and used without further purification. In a typical procedure, 1 g of pyromellitic acid were placed in a ceramic boat and inserted into the zone 1 of a tubular furnace under argon (200 mL/min) and at atmospheric pressure. The temperature of zone 2 was raised to 850° C. with a heating rate of 1° C./s. When the desired temperature was reached, the temperature of zone 1 was also increased to 450° C. and left for 30 min. Then, the furnace was cooled down to room temperature under argon, and the pure carbon spheres were collected from the quartz tube and used without any further process.

Example 5. Pyromellitic acid (96%) was purchased from Sigma-Aldrich and used without further purification. In a typical procedure, 1 g of mellitic acid were placed in a ceramic boat and inserted into the zone 1 of a tubular furnace under argon (200 mL/min) and at atmospheric pressure. The temperature of zone 2 was raised to 650° C. with a heating rate of 1° C./s. When the desired temperature was reached, the temperature of zone 1 was also increased to 450° C. and left for 30 min. Then, the furnace was cooled down to room temperature under argon. The impure carbon spheres were formed via this procedure.

Example 6. Pyromellitic dianhydride (97%) was purchased from Sigma-Aldrich and used without further purification. In a typical procedure, 1 g of pyromellitic dianhydride were placed in a ceramic boat and inserted into the zone 1 of a tubular furnace under argon (200 mL/min) and at atmospheric pressure. The temperature of zone 2 was raised to 700° C. with a heating rate of 1° C./s. When the desired temperature was reached, the temperature of zone 1 was also increased to 450° C. and left for 30 min. Then, the furnace was cooled down to room temperature under argon, and the pure carbon spheres were collected from the quartz tube and used without any further process.

Example 7. Pyromellitic dianhydride (97%) was purchased from Sigma-Aldrich and used without further purification. In a typical procedure, 1 g of pyromellitic dianhydride were placed in a ceramic boat and inserted into the zone 1 of a tubular furnace under argon (200 mL/min) and at atmospheric pressure. The temperature of zone 2 was raised to 800° C. with a heating rate of 1° C./s. When the desired temperature was reached, the temperature of zone 1 was also increased to 450° C. and left for 30 min. Then, the furnace was cooled down to room temperature under argon, and the pure carbon spheres were collected from the quartz tube and used without any further process.

Example 8. Pyromellitic dianhydride (97%) was purchased from Sigma-Aldrich and used without further purification. In a typical procedure, 1 g of pyromellitic dianhydride were placed in a ceramic boat and inserted into the zone 1 of a tubular furnace under argon (200 mL/min) and at atmospheric pressure. The temperature of zone 2 was raised to 900° C. with a heating rate of 1° C./s. When the desired temperature was reached, the temperature of zone 1 was also increased to 450° C. and left for 30 min. Then, the furnace was cooled down to room temperature under argon, and the pure carbon spheres were collected from the quartz tube and used without any further process.

Example 8. Pyromellitic dianhydride (97%) was purchased from Sigma-Aldrich and used without further purification. In a typical procedure, 1 g of pyromellitic dianhydride were placed in a ceramic boat and inserted into the zone 1 of a tubular furnace under argon (200 mL/min) and at atmospheric pressure. The temperature of zone 2 was raised to 650° C. with a heating rate of 1° C./s. When the desired temperature was reached, the temperature of zone 1 was also increased to 450° C. and left for 30 min. Then, the furnace was cooled down to room temperature under argon. The impure carbon spheres were formed via this procedure.

Example 10. Pyromellitic acid (97%) and urea 99.0%) were purchased from Sigma-Aldrich and used without further purification. In a typical procedure, 1 g of pyromellitic acid and 1 of urea were mixed and placed in a ceramic boat and inserted into the zone 1 of a tubular furnace under argon (200 mL/min) and at atmospheric pressure. The temperature of zone 2 was raised to 800° C. with a heating rate of 1° C./s. When the desired temperature was reached, the temperature of zone 1 was also increased to 450° C. and left for 30 min. Then, the furnace was cooled down to room temperature under argon. The carbon spheres were not formed via this procedure.

Example 11. Trimesic acid (95%) was purchased from Sigma-Aldrich and used without further purification. In a typical procedure, 1 g of trimesic acid were placed in a ceramic boat and inserted into the zone 1 of a tubular furnace under argon (200 mL/min) and at atmospheric pressure. The temperature of zone 2 was raised to 800° C. with a heating rate of 1° C./s. When the desired temperature was reached, the temperature of zone 1 was also increased to 450° C. and left for 30 min. Then, the furnace was cooled down to room temperature under argon. The carbon spheres were not formed via this procedure.

Example 12. Terephthalic acid (98%) was purchased from Sigma-Aldrich and used without further purification. In a typical procedure, 1 g of terephthalic acid were placed in a ceramic boat and inserted into the zone 1 of a tubular furnace under argon (200 mL/min) and at atmospheric pressure. The temperature of zone 2 was raised to 800° C. with a heating rate of 1° C./s. When the desired temperature was reached, the temperature of zone 1 was also increased to 450° C. and left for 30 min. Then, the furnace was cooled down to room temperature under argon. The carbon spheres were not formed via this procedure.

Example 13. Mellitic acid (99%) was purchased from Sigma-Aldrich and used without further purification. In a typical procedure, 1 g of mellitic acid were placed in a ceramic boat and inserted into the zone 1 of a tubular furnace under argon (200 mL/min) and at atmospheric pressure. The temperature of zone 2 was raised to 800° C. with a heating rate of 1° C./s. When the desired temperature was reached, the temperature of zone 1 was also increased to 450° C. and left for 30 min. Then, the furnace was cooled down to room temperature under argon. The carbon spheres were not formed via this procedure.

What is claimed is:

1. A material for CO₂ adsorption comprising: a porous carbon sphere material between 10 nm and 1 μm in diameter, with a surface area of at least 600 m²/g, and a total pore volume of at least 0.15 cm³/g, wherein 100% of pores of the porous material have diameters of less than 1 nm as measured from CO₂ sorption isotherms using the density functional theory (DFT) method, wherein the porous material has an oxygen content of less than about 12 wt % as measured by X-ray photoelectron spectroscopy, and wherein the porous material has a CO₂ adsorption capacity of more than about 1 mmol/g at 25° C.

2. The material of claim 1, wherein more than 50% of pores of the porous material have diameters of less than 0.5 nm as measured from CO₂ sorption isotherms using the DFT method.

3. The material of claim 1, wherein the porous material has an oxygen content of less than about 5.3 wt % as measured by X-ray photoelectron spectroscopy.

4. The material of claim 1, with a surface area of at least 800 m²/g.

5. The material of claim 1, with a total pore volume of at least 0.19 cm³/g.

6. The material of claim 1, wherein the porous material has a CO₂ adsorption capacity of more than about 4 mmol/g at 0° C.

7. A method of forming the porous carbon sphere material of claim 1, comprising:
a. heating an aromatic poly-carboxylic acid or anhydride precursor in the first heated zone of a reactor at a temperature sufficient to volatilize the precursor;
b. Flowing an inert carrier gas to transport the volatilized precursor into a second heated zone of the reactor;
c. Heating the precursor vapors in the second zone of a reactor at a temperature of between about 700° C. and 900° C.

8. The method as claimed in claim 7, wherein the aromatic poly-carboxylic acid or anhydride precursor is chosen from pyromellitic acid, pyromellitic anhydride and pyromellitic dianhydride.

9. The method as claimed in claim 8, wherein the precursor is heated to a temperature of between about 400° C. and 450° C. at 1 atmosphere pressure.

10. The method as claimed in claim 8, wherein inert carrier gas is chosen from argon and nitrogen.

11. The method as claimed in claim 8, wherein the precursor vapors in the second zone of a reactor at a temperature of about 800° C.
